(19) United States
(12) Patent Application Publication
(10) Pub. No.: US 2009/0224937 A1
(43) Pub. Date: Sep. 10, 2009

(54) DEVICE FOR REMOTE READING OF FLUID METERS

(75) Inventors: Eric Gillette, Boulogne Billancourt (FR); Marc Guerquin, Noisy Le Roi (FR)

Correspondence Address: CONNOLLY BOVE LODGE & HUTZ LLP, 1875 EYE STREET, N.W., SUITE 1100, WASHINGTON, DC, 20006, US

(73) Assignee: SUEZ ENVIROMMENEMT, PARIS (FR)

(21) Appl. No.: 12/160,363

(22) PCT Filed: Jan. 9, 2007
(86) PCT No.: PCT/FR07/00032

§ 371 Date: Feb. 10, 2009

(30) Foreign Application Priority Data
Jan. 10, 2006 (FR) 06 00191

(51) Int. Cl. G08C 17/02

(52) U.S. Cl. 340/870.02

(57) ABSTRACT

Device for remote reading of a fluid meter comprising a mechanical meter (1), a transducer (2) placed against the meter (1) and converting the mechanical movements of the said meter (1) into electric pulses, an assembly (3) for acquiring the electric pulses comprising at least one radio transmitter for transmitting the acquired information and an antenna (4). The said acquisition assembly (3) is placed against the transducer (2) to which it is fixedly attached, one and the same energy source provides the power supply of the transducer (2) and of the assembly (3) and the said antenna (4) is connected to the radio transmitter by means of a cable (6), so that the antenna (4) may be placed at a distance from the meter (1).

The present invention relates generally to devices for remote reading of fluid meters, for example water or gas meters, and more particularly to devices comprising a mechanical technology water meter, a transducer placed up against the meter and converting the mechanical movements of said meter into electrical pulses, an assembly for collecting electrical pulses comprising at least one radio transmitter for transmitting the information collected and an antenna.

The distribution service companies for water, gas or even electricity are led to measure the fluids they distribute on their networks. The meter points are mainly customers' meters, whether these are direct billing meters, called main or primary meters, or distribution meters, called submeters in the world of water distribution.

There are nonetheless other metering points, for example flow monitoring meters within the distribution network, or even points for measuring diverse parameters such as, for example, pressure or quality parameters.

Historically, the reading of meters spread over the distribution network in this way has been carried out manually. For various reasons, in particular the costs, the administrators have sought with their suppliers to create radio modules allowing meters to be read at a short distance. This has various objectives, sometimes economic, to reduce unit reading times and hence the related costs, but also sometimes to eliminate access constraints: meters may be located inside the properties of customers and/or in difficult to access inspection wells.

However, this mode of remote transmission still required the movement of reading personnel who positioned themselves close to the meters. In this context, the remote reading of water counters is realized on the basis of the following elements:
a water meter equipped with a system converting the mechanical movements of the water meter into an electrical signal, thus making this meter communicate;
a reader of the electrical signal from the water meter; and
an assembly for collecting electrical signals, also integrating a radio transmitting the information collected.

The electrical signal reader and the collector assembly are linked by an electrical wire seldom exceeding a few meters, on account of the impedances and signal quality losses in an electrical wire.

To date there exist different variants of these systems. These variants are distinguished in particular by:
the mode of communication between the meter and the collector system. These systems are divided into systems known as pulse emitter systems, sending one pulse per counter unit, which necessitates recounting the pulses, and encoder systems allowing the value indicated by the counter totalizer to be read directly;
the modes of use of the radio, either walk-by or drive-by, requiring a reader to pass close to the radios, or fixed location readers by equipping the neighboring buildings with a reception device. These fixed locations then in turn communicate through more conventional telephone, RTC, GSM, GPRS or other connections.

Despite these variants, the problem for installers has been minimizing the cost of equipment by attempting to integrate it. In particular, the electrical signal reader is designed by the manufacturers of meters and is therefore dependent on said manufacturers. These systems all comprise:
an electronic module, which requires a battery for electrical autonomy and an electronic card; and
a collector and radio transmitter assembly, also comprising a battery and electronic card.

The module and the collector and radio transmitter assembly are particularly well suited to the meters situated in an apartment, where the radio transmission poses few problems. Conversely, they have proven more difficult to use in basements, where water meters are naturally installed in the case of buildings or detached houses. They have proven equally difficult to use in water meter wells where, beyond the depth below ground which reduces the transmission qualities of probes, the presence of a well cover accentuates these constraints.

In fact, radio transmission through concrete walls or the ground is difficult or impossible. With a collector and radio transmitter assembly connected to the module by a wire of a few meters length it becomes possible:
to install the pulse emitter or the communication system on the meter; and
to place the radio system further away, generally in height (for example, on the roof of the basement or close to the well cover), where radio transmission takes place much more easily.

In practice, analysis of the constraints of basement fitting shows, independently of technical analyses of the products, that there are the following geographical constraints:
the system for converting the mechanical signal is necessarily located on the meter; and
the point of radio-wave transmission, and not the radio itself, must be able to be distinct from the first point in order to optimize the fitting.

In order to eliminate the drawbacks with existing devices, the inventors have developed, this being the subject of the invention, a device for remote reading of a fluid meter comprising a mechanical meter, a transducer placed up against the meter and converting the mechanical movements of said meter into electrical pulses, an assembly for collecting electrical pulses comprising at least one radio transmitter for transmitting the information collected and an antenna, which is characterized in that said collector assembly is positioned up against the transducer to which it is joined, in that the same energy source ensures the power supply to the transducer and to the assembly, and in that said antenna is connected to said at least one radio transmitter by means of a cable, such that the antenna may be placed at a distance from the meter.

Preferably, said collector assembly and the transducer are positioned in such a way that they can be integrated in the same case and are driven by a common electronic card.

More particularly, in the case of a meter positioned in a well, said antenna is positioned in the upper part of said well.

More particularly still, in the case of a meter positioned in a well equipped with a well cover, said antenna is integrated with the well cover of said well.

In this particular case, if the well cover is metallic, said antenna consists of the well cover of the well.

Still in this case, if the well cover is made of an electrically nonconductive material, said antenna is built into or molded into said well cover.

In all the preceding cases where the meter is positioned in a well equipped with a well cover, the latter will be able to comprise, on its inner face, a connector linked to one end of the antenna and into which the radio cable for linking to the transmitter can be plugged.

Preferably, whatever the device according to the invention, said cable is a coaxial cable.

More preferably, said energy source is chosen from among primary cells and/or batteries.

In a conventional manner, said radio transmitter operates at free frequencies.

More particularly, in the scope of the invention, said radio transmitter operates at a dedicated frequency. In this scope, the power of said radio transmitter may be greater than the maximum limit permitted for a transmitter at free frequencies.

More particularly, the remote reading device according to the invention additionally comprises a radio receiver enabling communication between the device and a collection center and vice versa.

Particularly in this implementation, the remote reading device according to the invention enables information to be received from said center and especially a timestamp.

The invention will be better understood on reading the detailed description below, with reference to the drawings, which are in no way limiting, in which:

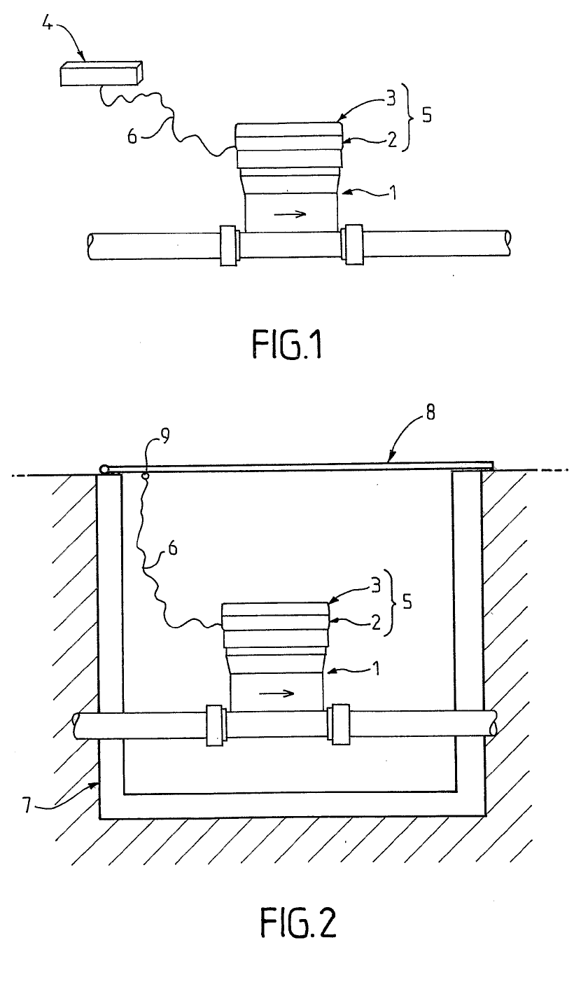

FIG. 1 shows a device according to the present invention for which the assembly for collecting electrical pulses comprising a radio transmitter and the transducer placed on the volume meter are integrated and the antenna is offset;

FIG. 2 shows a device according to the present invention, conforming with FIG. 1, positioned in a well equipped with a metal well cover acting as an antenna;

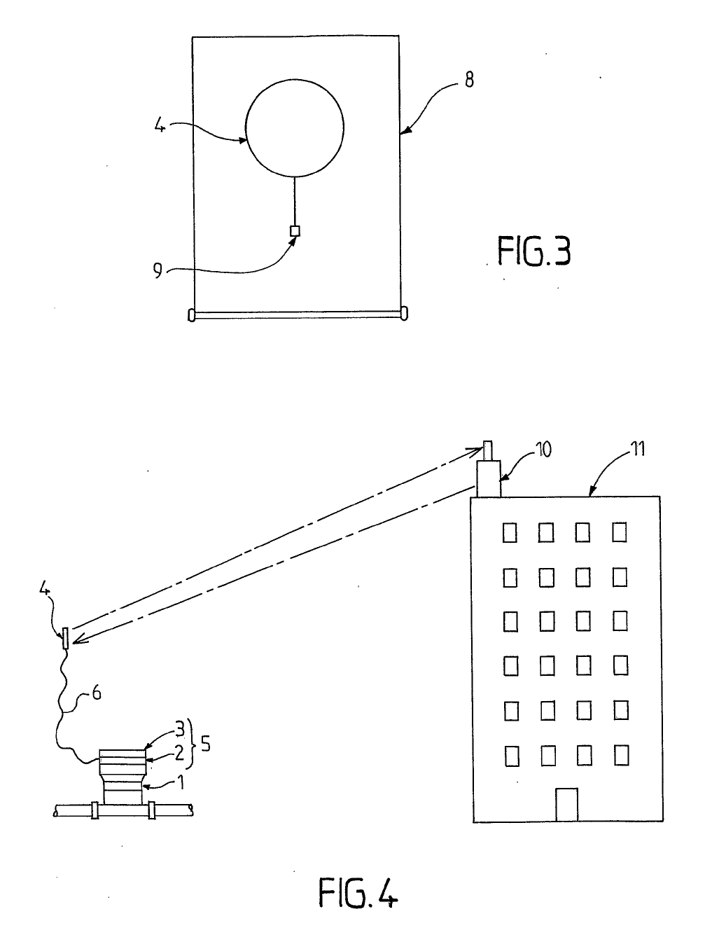

FIG. 3 shows, viewed from above, a well cover made of an electrically nonconductive material and into which said antenna is molded; and

FIG. 4 shows the operating schema of a device according to the invention comprising a transmitter and a radio receiver.

FIG. 1 shows a device for remote reading of a volume meter for a fluid, in particular water, according to the invention, comprising a mechanical meter 1, a transducer 2 placed up against the meter 1 and converting the mechanical movements of said meter 1 into electrical pulses, an assembly for collecting electrical pulses 3 comprising at least one radio transmitter for transmitting the information collected, and an antenna 4.

This device is designed such that said collector assembly 3 is positioned up against the transducer 2 to which it is joined, and that the same energy source ensures the power supply to the transducer and to the assembly 3. Finally, said antenna is connected to the radio transmitter by means of a cable 6, such that the antenna may be placed at a distance from the meter.

In this representation, said collector assembly 3 and the transducer 2 are, in addition, positioned so as to be able to be integrated in the same unit or case 5 and are driven by a common electronic card.

The transfer of the electrical pulses generated by the transducer 2 to the collector assembly 3 is therefore carried out in a direct manner.

This device eliminates all the drawbacks previously set out and produces significant economies by minimizing the production cost of the device and by reducing maintenance and consumption to a minimum.

In practice the cable 6 linking the antenna 4 to the collector device 3 is a coaxial cable.

This is therefore precisely the most favorable case where the starting point of the radio wave emitted is separated from the source and can be positioned at the most suitable location, through the offset of the antenna 4 alone, of which the cable 6 that links it to the collector assembly 3 may be very long. Costs have also been minimized by using only a single and unique energy source, for example primary cells or batteries, and by producing only a single and unique electronic card.

The device according to the invention may use a radio operating at a free frequency or a dedicated frequency. The appeal in using a dedicated frequency is being able to increase the transmitter power and hence the usable distance between the transmitter of the device and the receiver. In the case of free frequencies, in particular in an urban environment, the range of such a device is only a few tens of meters whereas it reaches 500 meters to 1 kilometer with a transmitter power of about ten watts at a dedicated frequency. In an open field, i.e. with low urbanization, the range of the device at a dedicated frequency may reach several kilometers. It is therefore possible to reduce the number of repeaters, or even to eliminate them. These repeaters are located to pick up and transmit the information received from a meter through to a collection center. By increasing the range of the transmitters, it is therefore possible to reduce the use of receivers and hence also to reduce the cost of an installation.

FIG. 2 illustrates a typical example of the flexibility of the use and installation provided by the device according to the invention.

By offsetting the antenna 4, it is hence possible to use any metal or electrically conductive device to play this role. In the case represented here, the water volume meter 1 is installed in a buried well 7, equipped with a well cover 8. It is therefore possible to use this well cover 8 as an antenna 4 by connecting it by means of the cable 6 to the collector assembly 3. To facilitate this connection, a connector 9 may be provided, located on the well cover 7 and into which the radio cable 6 for linking to the transmitter can be plugged.

In the case where the well cover 8 is made of an electrically nonconductive material, said antenna 4 is then built into or molded into said well cover 8 (FIG. 3). In the same way, a connector 9 is provided, linked to one end of the antenna 4 and into which the radio cable 6 for linking to the transmitter can be plugged.

The fact that the well cover 8 is used as the antenna 4 or as the support for an antenna 4 makes it possible, in the case of a buried water meter 1, to have a starting point of the radio wave situated at ground level and no longer a certain distance below the ground. This arrangement allows the efficiency of the communication between the transmitter and the receiver to be improved.

In addition, the device will allow easier installation. This is because the technician will no longer have to operate in the well to attach an antenna or a radio unit, which is sometimes difficult due to the difficulty of accessing the interior of the well. It suffices to fit the meter according to the invention and to connect the cable to the well cover in the case of a metal well cover, and perhaps to replace the well cover with another where a connector will be located. It is the same for wells with a well cover that is not an electrical conductor. Simply replacing the well cover with a well cover such as shown in FIG. 3 will enable straightforward connection of the meter to its antenna and a practical installation of the whole device.

FIG. 4 shows the operating schema of a use of the device according to the invention for which the collector assembly 3 additionally comprises a radio receiver enabling communication between the device and a collection center and vice versa.

However, if the center is too far away from the meter for direct communication, it is possible to interpose a repeater 10 between the meter 1 and the center, for example on the roof of a building 11 so as to be able to receive information from the meter and transfer it through to the center and vice versa. This arrangement is characteristic for systems operating at a free frequency, whereas the uses with dedicated frequency allow these constraints to be reduced or even eliminated.

It is hence possible to monitor consumption in real time, i.e. the meter rate, and to detect a leak in the case of a regular rate, for example at night.

Conversely, adding a receiver makes it possible to communicate with the meter and hence, for example, to have a solution for timestamping the meter and consequently to be able to create a network of meters, known as “blue” meters, timestamped so as to create a blue period in which consumption is billed at a preferential price.

It then becomes possible to stimulate consumers, through these reduced prices, to use the fluid, for example water, at set times outside the current consumption peaks, in particular for public watering of parks, golf courses, stadiums, gardens, green spaces etc.

The additional positioning of a screen near the meter then allows visualization of the time slot and the corresponding price.

The invention thus described is perfectly suited to the distribution of water, but the technology can be perfectly transposed to any other fluid with a mechanically measured flow rate, such as gas for example.

1. A device for remote reading of a fluid meter comprising a mechanical meter, a transducer placed up against the meter and converting the mechanical movements of said meter into electrical pulses, an assembly for collecting electrical pulses comprising at least one radio transmitter for transmitting the information collected and an antenna, wherein said collector assembly is positioned up against the transducer to which it is joined, in that the same energy source ensures the power supply to the transducers and to the assembly, and in that said antenna is connected to said at least one radio transmitter by means of a cable, such that the antenna may be placed at a distance from the meter.

2. The remote reading device as claimed in claim 1, wherein said collector assembly and the transducer are positioned in such a way that they can be integrated in the same case and are driven by a common electronic card.

3. The remote reading device as claimed in claim 1 for a meter located in a well, wherein said antenna is positioned in the upper part of said well.

4. The remote reading device as claimed in claim 3 for a meter located in a well equipped with a well cover, wherein said antenna is integrated with the well cover of said well.

5. The remote reading device as claimed in claim 4, wherein the well cover is metallic and said antenna consists of the well cover of the well.

6. The remote reading device as claimed in claim 4, wherein the well cover is made of an electrically nonconductive material and said antenna is built into or molded into said well cover.

7. The remote reading device as claimed in claim 4, wherein the well cover comprises, on its inner face, a connector linked to one end of the antenna and into which the radio cable for linking to the transmitter can be plugged.

8. The remote reading device as claimed in claim 1, wherein said cable is a coaxial cable.

9. The remote reading device as claimed in claim 1, wherein said energy source is chosen from among primary cells and/or batteries.

10. The remote reading device as claimed in claim 1, wherein said radio transmitter operates at free frequencies.

11. The remote reading device as claimed in claim 1, wherein said radio transmitter operates at a dedicated frequency.

12. The remote reading device as claimed in claim 11, wherein the power of said radio transmitter is greater than the maximum limit permitted for a transmitter at free frequencies.

13. The remote reading device as claimed in claim 10, wherein it additionally comprises a radio receiver enabling communication between the device and a collection center and vice versa.

14. The remote reading device as claimed in claim 13, wherein it enables information to be received from said center and especially a timestamp.
